(19) United States
(12) Patent Application Publication
(10) Pub. No.: US 2003/0182918 A1
(43) Pub. Date: Oct. 2, 2003

(54) Easy change replacement mower blade

(76) Inventors: John L. Stone, Valley City, OH (US); Rodney A. Stone, North Eaton, OH (US)

Correspondence Address: Richard C. Litman, LITMAN LAW OFFICES, LTD., P.O. Box 15035, Arlington, VA, 22215, US

(21) Appl. No.: 10/391,636

(22) Filed: Mar. 20, 2003

Related U.S. Application Data
(60) Provisional application No. 60/368,942, filed on Apr. 2, 2002.

(51) Int. Cl. A01D 34/73

(52) U.S. Cl. 56/255; 56/295

(57) ABSTRACT

A rotary lawn mower blade assembly having replaceable cutting edge members which may be replaced without replacing an entire blade or sharpening the used blade. The cutting edge members slide into place on corresponding “T”-shaped tongues of the blade body until encountering an integral stop. The cutting blade member is securely held in place by a blade retainer having a rectilinear portion which mates with a retainer stud fastened in the blade body and an extension plate portion with mounting cap screws reaching through the blade retainer extension plate into the cutting blade member. In another embodiment the cutting edge members are secured by set screw extending downward from the upper surface of the cutting edge member and bearing against the upper side of the “T”-shaped tongue of the blade body.

### CROSS-REFERENCE TO RELATED APPLICATION

This application claims the benefit of U.S. Provisional Patent Application Ser. No. 60/368,942, filed Apr. 2, 2002.

### BACKGROUND OF THE INVENTION

1. Field of the Invention

The present invention relates to rotary lawn mower blades. More particularly, the present invention relates to a lawn mower blade having replaceable cutting edge members.

2. Description of Related Art

During the use of rotary bladed lawn mowers it is inevitable that the cutting blades become dull over a period of use, or hard objects such as stones are encountered which damage the cutting edges. There is substantial effort required and downtime suffered when removing the blade from the mower for sharpening or replacement of the blade. It would be desirable to provide a lawn mower blade having replaceable cutting edge members which can be replaced quickly and will restore the blade to its original sharpness without going through a sharpening procedure. It would also be desirable that the replaceable cutting edge members be securely mounted on the blade in order to assure safe operation.

U.S. Pat. No. 5,467,586, issued Nov. 21, 1995, to Lin et al., describes a lawn mower blade wherein a removable sharp cutting surface is attached to the edge at each end of a mower blade.

U.S. Pat. No. 5,619,847, issued Apr. 15, 1997, to Cox, Jr., describes a disposable lawnmower blade in which the rotary blade can be quickly switched out and replaced with a fresh sharp one without the use of tools in a matter of seconds. The disposable blade fits onto the original mower blade.

U.S. Pat. No. 5,303,535, issued Nov. 21, 1995, to Smith, describes a lawn mower blade with support tongues arranged to mount inserts below each tongue.

U.S. Pat. No. 2,869,311, issued Jan. 20, 1959, to Beeston, Jr., describes a lawn mower blade assembly having replaceable blades having interlocking prongs on the blade body and corresponding with closed receiver structures on the replacement blades. The '300 Patent relies only on centrifugal force to maintain the replacement blades in place on the blade body.

U.S. Pat. No. 3,327,460, issued Jun. 27, 1967, to Blackstone describes a lawn mover blade assembly having replaceable blades held in place by centrifugal force and a through bolt.

None of the above inventions and patents, taken either singly or in combination, is seen to describe the instant invention as claimed.

### SUMMARY OF THE INVENTION

The present invention is a rotary lawn mower blade assembly having replaceable cutting edge members which allow the restoration of the blade to its original sharpness without sharpening the old blade or replacement of a new blade. The cutting edge members slide into place on corresponding “T”-shaped tongues of the blade body until encountering an integral stop. The cutting blade member is securely held in place by a blade retainer having a rectilinear portion which mates with a retainer stud fastened in the blade body and an extension plate portion with mounting cap screws reaching through the blade retainer extension plate into the cutting blade member. In another embodiment of the invention, the cutting edge members are held in place by set screws and no blade retainer is employed.

Accordingly, it is a principal object of the invention to provide a replaceable cutting edge member for a rotary lawnmower blade.

It is another object of the invention to provide a replaceable cutting edge member as above which can be replaced without replacing the entire lawnmower blade or sharpening the original blade.

It is a further object of the invention to provide a replaceable cutting edge member which is may be securely mounted on the blade.

Still another object of the invention is to provide a replaceable cutting edge member which requires only simple tools to remove and change the member.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of an easy change replacement mower blade assembly according to the present invention.

FIG. 2 is an end view of the mower blade of FIG. 1.

FIG. 3 is an exploded view of the mower blade of FIG. 1

FIG. 4 is a perspective view of another embodiment of the easy change replacement mower blade assembly according to the present invention.

FIG. 5 is an end view of the mower blade of FIG. 4.

Similar reference characters denote corresponding features consistently throughout the attached drawings.

### DETAILED DESCRIPTION OF THE PREFERRED EMBODIMENT

The present invention is a rotary lawn mower blade assembly having replaceable cutting edge members which may be replaced without replacing the entire mower blade or sharpening the original blade. The cutting edge members slide into place on corresponding interlocking “T”-shaped tongues of the blade body until encountering an integral stop. The cutting blade member is securely held in place by a blade retainer having a rectilinear portion which mates with a retainer stud fastened in the blade body and an extension plate portion with mounting cap screws reaching through the blade retainer extension plate into the cutting blade member. In another embodiment the replacement cutting blade members are secured to the blade by set screws.

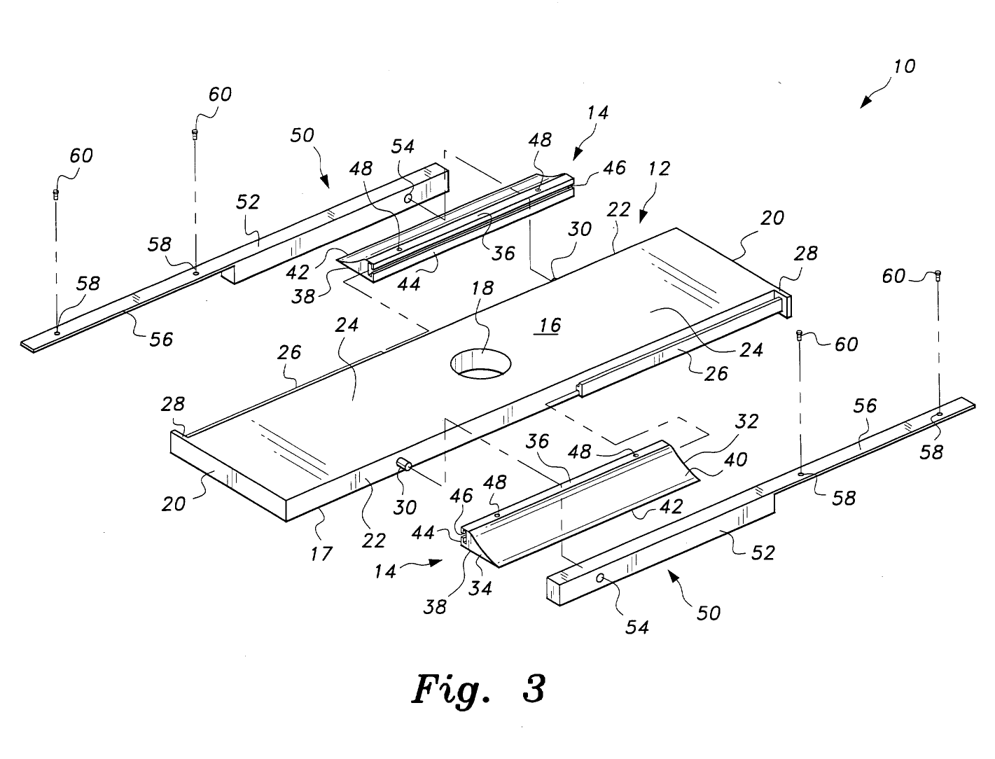

Referring to FIGS. 1-3, there is shown a perspective view, an end view, and an exploded view, respectively, of the lawn mower blade assembly of the present invention. Replaceable edge blade assembly 10 comprises blade body 12 having replaceable cutting blade members 14. Blade body 12 has an upper surface 16, an underside 17, a centrally located mounting hole 18 for mounting on a mower rotating shaft (not shown), ends 20, sides 22, and blade body cutting edge portions 24. Respective interlocking tongues such as “T”-shaped tongues 26 are located in the sides of blade body cutting edge portions 24 and facing in opposing directions so as to be forward facing during blade assembly rotation. Integral body stops 28 are located at ends 22 beyond each respective tongue 26. A retainer stud 30 extends from each side 22 and is sufficiently spaced therealong from respective tongues 26 to allow easy removal and mounting of replacement cutting blade members 14 on the tongues 26.

Each replaceable cutting blade member 14 has an outer end 32 and an opposing inner end 34, an upper surface 36 and an opposing underside 38, and a bevel side 40 sloping outward and downward from upper surface 36 to under side 38 forming blade edge 42 at the intersection of bevel side 40 and underside 38. Bevel side 40 may be flat or concave as shown. Blade inner side 44 is vertically oriented, located opposite bevel side 40 and has a groove so sized and shaped as to interlock with the tongue 26 of the above-described blade body 12 such as “T”-shaped groove 46 cut therein along its length. Replaceable cutting blade member 14 has vertically oriented, upwardly opening tapped threaded mounting bores 48 therein, spaced along blade upper surface 40.

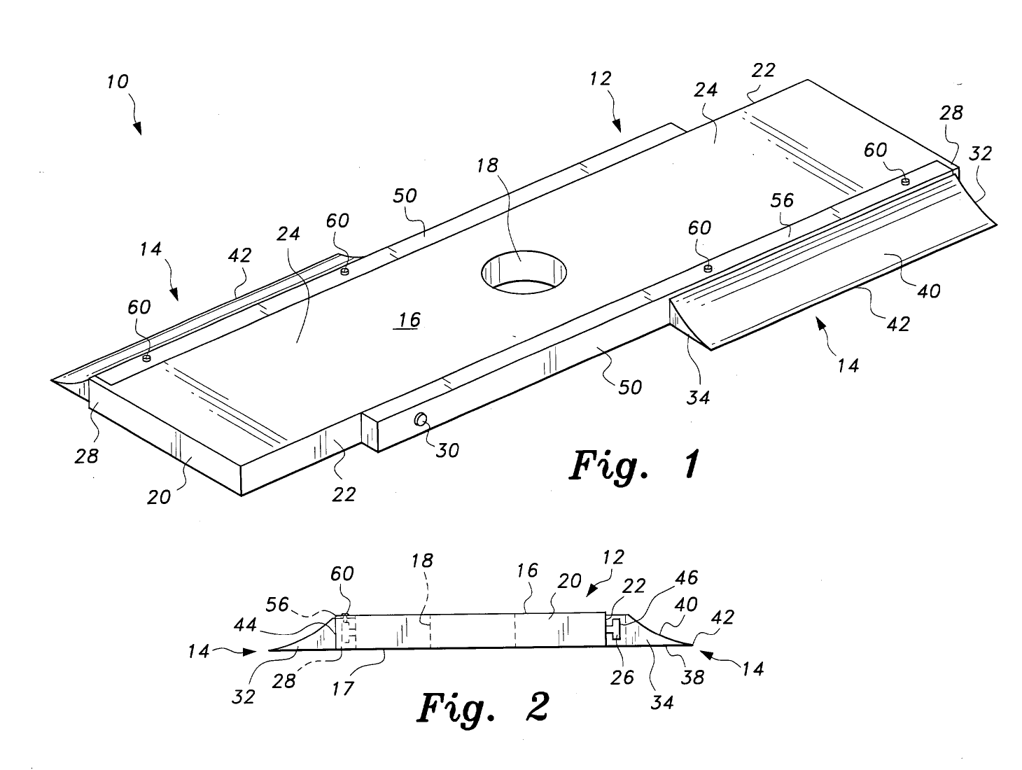

Blade retainers 50 secures cutting blade members 14 on blade body 12 and comprise a rectilinear stud receiver portion 52 having a retainer stud receiving bore 54 located therein so as to mate with blade retainer stud 30 of blade body 12. (Note that FIG. 2 is shown without blade retainer 50 in place.) Blade retainers 50 removably abut the inner end of corresponding “T”-shaped tongues 26. Retainers 50 further comprise an extension plate 56 extending above a corresponding replaceable cutting blade member 14 along blade upper surface 38 and having an end abutting a blade body stop 28. Extension plate 56 has extension plate mounting cap screw bores 58 corresponding to threaded mounting bores 48 so as to allow the insertion of mounting cap screws 60 therethrough and into mounting bores 48, thereby securing replaceable cutting blade members 14 on blade body 12.

In operation, dull or damaged replaceable cutting blade member 14 is removed from blade body 12 by removing mounting cap screws 60. This allows blade retainer 50 to be removed and cutting blade member 14 to be slid off tongue 26. A replacement cutting blade member 14 is aligned with tongue 26 and slid onto blade body 12 up to stop 28. Blade retainer 50 is mounted on blade body 12 by aligning stud receiving bore 54 with blade retainer stud 30 and sliding blade retainer 50 against blade body side 22. Blade retainer 50 is then rotated around stud 30 until blade retainer extension plate 56 rests on blade upper surface 36. Mounting cap screws 60 are then inserted through mounting cap screw bores 58 and secured by turning in threaded mounting bores 48 of cutting blade member 14.

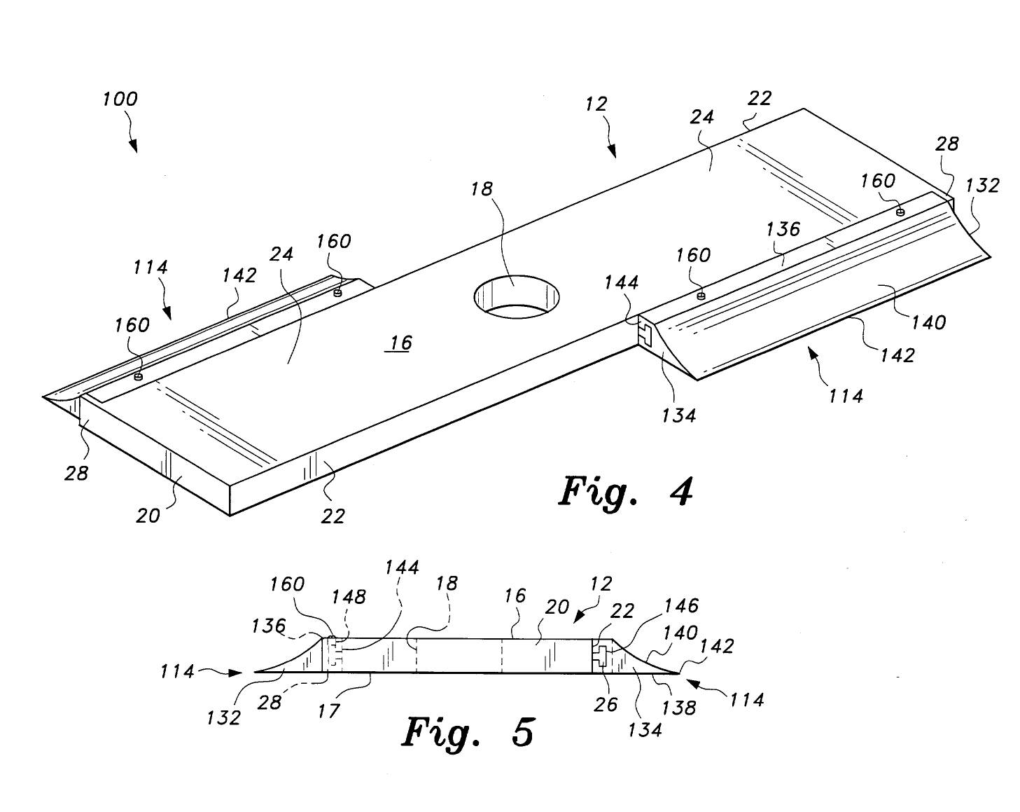

Referring to FIGS. 4 and 5, there is shown a perspective view and an end view, respectively, of another embodiment of the lawn mower blade assembly of the present invention. Replaceable edge blade assembly 100 comprises blade body 12 having replaceable cutting blade members 114. Blade body 12 has an upper surface 16, an underside 17, a centrally located mounting hole 18 for mounting on a mower rotating shaft (not shown), ends 20, sides 22, and blade body cutting edge portions 24. Respective interlocking tongues such as “T”-shaped tongues 26 are located in the sides of blade body cutting edge portions 24 and facing in opposing directions so as to be forward facing during blade assembly rotation. Integral body stops 28 are located at ends 22 beyond each respective tongue 26.

Each replaceable cutting blade member 114 has an outer end 132 and an opposing inner end 134, an upper side 136 and an opposing underside 138, and a bevel side 140 sloping outward and downward from upper side 136 to under side 138 forming blade edge 142 at the intersection of bevel side 140 and underside 138. Bevel side 140 may be flat or concave as shown. Blade inner side 144 is vertically oriented, located opposite bevel side 140 and has a groove so sized and shaped as to interlock with the tongue 26 of the above-described blade body 12 such as “T”-shaped groove 146 cut therein along its length. Replaceable cutting blade member 114 has vertically oriented, upwardly opening, tapped threaded mounting bores 148 therein, spaced along blade upper surface 136 and extending through to the upper surface of the groove 146. Set screws 160 are turned in threaded mounting bores 148 until they bear against the upper surface of “T”-shaped tongue 26, thereby securing replacement blade member 114.

In operation, dull or damaged replaceable cutting blade member 114 is removed from blade body 12 by loosening set screws 60. This allows cutting blade member 114 to be slid off tongue 26. A replacement cutting blade member 114 is aligned with tongue 26 and slid onto blade body 12 up to stop 28. Mounting set screws 160 then secure cutting blade member 114 on blade body 12 by turning in threaded mounting bores 148 of cutting blade member 14 until tight against the upper surface of “T”-shaped tongue 26.

The various parts of the inventive blade assembly are preferably made of steel or other durable material. The replaceable cutting blade member may be of hardened steel so as to maintain a sharp edge. Any shape of interlocking tongue and groove design for mounting the cutting blade member is contemplated by the present invention.

It is to be understood that the present invention is not limited to the sole embodiment described above, but encompasses any and all embodiments within the scope of the following claims.

We claim:

1. A rotary lawn mower replaceable blade assembly comprising:
a rotatable elongated blade body having opposing sides, opposing ends, an upper surface and an underside and defining cutting edge portions at opposing ends thereof;
said cutting edge portions each having an having an inner end and an outer end and an interlocking tongue extending the length thereof in the direction of rotation of the rotary blade assembly, each said interlocking tongue ending in a stop at is outer end; and
replaceable cutter blade members, each having an inner side and a bevel side, said inner side defining an interlocking groove extending the length of said cutter blade member, so sized and configured as to slidably engage in a radial direction one of the said interlocking tongues of said cutting edge portions, said bevel side defining a cutting edge extending therealong.

2. The blade assembly of claim 1, said interlocking tongue is “T”-shaped along its length.

3. The blade assembly of claim 1, each said cutter blade members having an upper surface and defining at least one tapped vertical bore extending into said cutter blade member from said upper surface for receiving a threaded mounting cap screw.

4. The blade assembly of claim 3, further comprising a blade retainer affixed to said blade body and having a blade retainer extension plate extending along said cutter blade member upper surface and defining at least one vertical bore extending therethrough corresponding with said cutter blade tapped bore, and a threaded mounting cap screw for threadingly engaging said cutter blade member tapped vertical bore for securing said blade retainer extension plate to said cutter blade member.

5. The blade assembly of claim 4, further comprising a retainer stud extending outward from and spaced along each side said blade body from said cutter blade member, said retainer stud being spaced from said blade body for at least the length of said cutter blade member, said blade retainer having a rectilinear stud receiver portion having a retainer stud receiving bore so located as to receive said retainer stud when said blade retainer extension plate vertical bore is aligned with said cutter blade tapped bore.

6. The blade assembly of claim 5, wherein said rectilinear stud receiver portion of said blade retainer abuts said cutter blade member.

7. The blade assembly of claim 3, wherein each said cutter blade member defines two spaced tapped vertical bores extending into said cutter blade member from said upper surface each for receiving a threaded mounting cap screw for threadingly engaging each said cutter blade member tapped vertical bore said blade retainer extension defining two vertical bores extending therethrough corresponding with said cutter blade tapped bores, and corresponding threaded mounting cap screws for securing said blade retainer extension plate to said cutter blade member.

8. The blade assembly of claim 2, each said cutter blade members having an upper surface and defining at least one tapped vertical bore extending through said cutter blade member from said upper surface to said interlocking tongue for receiving a threaded set screw for securing said cutter blade members to said interlocking tongue.

9. The blade assembly of claim 8, wherein each of said cutter blade members defines two spaced tapped vertical bores, each for receiving a threaded set screw.

10. A rotary lawn mower replaceable blade assembly comprising:
a rotatable elongated blade body having opposing sides, opposing ends, an upper surface and an underside and defining cutting edge portions at opposing ends thereof;
said cutting edge portions each having an having an inner end and an outer end and an interlocking tongue extending the length thereof in the direction of rotation of the rotary blade assembly, each said interlocking tongue ending in a stop at is outer end; and
replaceable cutter blade members, each having an inner side and a bevel side, said inner side defining an interlocking groove extending the length of said cutter blade member, so sized and configured as to slidably engage in a radial direction one of the said interlocking tongues of said cutting edge portions, said bevel side defining a cutting edge extending therealong;
said interlocking tongue being “T”-shaped along its length;
each said cutter blade members having an upper surface defining two spaced tapped vertical bores extending into said cutter blade member from said upper surface for receiving a threaded mounting cap screw;
a blade retainer affixed to said blade body and having a blade retainer extension plate extending along said cutter blade member upper surface and defining two spaced vertical bores extending therethrough corresponding with said cutter blade tapped bores, and a threaded mounting cap screw for threadingly engaging each said cutter blade member tapped vertical bore for securing said blade retainer extension plate to said cutter blade member;
a retainer stud extending outward from and spaced along each side said blade body from said cutter blade member, said retainer stud being spaced from said blade body for at least the length of said cutter blade member, said blade retainer having a rectilinear stud receiver portion having a retainer stud receiving bore so located as to receive said retainer stud when said blade retainer extension plate vertical bore is aligned with said cutter blade tapped bore;
said rectilinear stud receiver portion of said blade retainer abutting said cutter blade member.

11. A rotary lawn mower replaceable blade assembly comprising:
a rotatable elongated blade body having opposing sides, opposing ends, an upper surface and an underside and defining cutting edge portions at opposing ends thereof;
said cutting edge portions each having an having an inner end and an outer end and a “T”-shaped interlocking tongue extending the length thereof in the direction of rotation of the rotary blade assembly, each said interlocking tongue ending in a stop at is outer end; and
replaceable cutter blade members, each having an inner side and a bevel side, said inner side defining an interlocking groove extending the length of said cutter blade member, so sized and configured as to slidably engage in a radial direction one of the said interlocking tongues of said cutting edge portions, said bevel side defining a cutting edge extending therealong.
each said cutter blade members having an upper surface and defining two spaced tapped vertical bores extending through said cutter blade member from said upper surface to said interlocking tongue and a threaded set screw corresponding to each tapped bore for securely engaging said cutter blade members with said cutter blade member.
